(19) United States
(12) Patent Application Publication
(10) Pub. No.: US 2024/0198180 A1
(43) Pub. Date: Jun. 20, 2024

(54) TRAINING COURSE RECOMMENDATION DEVICE AND TRAINING COURSE RECOMMENDATION METHOD

(71) Applicant: UNIWILL TECHNOLOGY INC., TAIPEI CITY (TW)

(72) Inventors: Chien-Yuan CHEN, TAIPEI CITY (TW); Chun-Cheng CHEN, TAIPEI CITY (TW); Shao-Hong YANG, TAIPEI CITY (TW); Jen-Sheng TSAI, TAIPEI CITY (TW)

(21) Appl. No.: 18/126,399

(22) Filed: Mar. 25, 2023

(30) Foreign Application Priority Data
Dec. 19, 2022 (TW) 111148751

(51) Int. Cl. A63B 24/00; A63B 71/06; G06F 40/40

(52) U.S. Cl. CPC A63B 24/0075; A63B 71/0622; G06F 40/40; A63B 2214/00

(57) ABSTRACT

A training course recommendation device and a training course recommendation method are provided. The training course recommendation device includes a course database, a rider database, and a course recommendation processing module. The course database is configured to store a plurality of riding training courses. The rider database is configured to store rider characteristic data and riding sensing data. The course recommendation processing module is configured to analyze the rider characteristic data and the riding sensing data to obtain a user riding characteristic vector, compare the user riding characteristic vector and a course characteristic vector of each of the plurality of riding training courses to obtain a plurality of matching values of the plurality of riding training courses, and set at least one recommendation course from the plurality of riding training courses according to the matching value(s) which is(are) greater than a threshold.

### BACKGROUND OF THE DISCLOSURE

### Technical Field

The disclosure generally relates to a recommendation device and recommendation method, and more particularly, to a training course recommendation device and training course recommendation method.

### Description of Related Art

As the awareness of health rises, more and more people pay attention to the benefits of exercise, and sports providers start to promote various kinds of sports. Among the many exercise options, riding a bicycle becomes a popular sport in recent years. Bicycling provides users with a good experience of enjoying the scenery while exercising, and the users have the option to choose the appropriate environment to adjust their exercise intensity, such as choosing a mountain road for high-intensity exercise or choosing a flat road for moderate exercise. However, there are still many inconveniences in outdoor sports, such as bad weather conditions, which may stop users to exercise.

To overcome the inconveniences of outdoor sports, riding bicycles on a bicycle trainer is one of the good options for indoor sports. The users ride bicycles indoors by using the bicycle trainer and enjoy a riding experience through simulated riding services as if they rode outdoors. However, due to the lack of real geographic environmental characteristics, users cannot freely choose the intensity of exercise indoors, so it is difficult to plan for moderate exercise or long-term exercise and indoor bicycling exercise is ineffective.

### SUMMARY OF THE DISCLOSURE

The present disclosed example is directed to a training course recommendation device that can provide users with efficient exercise training.

One of the exemplary embodiments is to provide a training course recommendation device that includes a course database, a rider database, and a course recommendation processing module. The course database is configured to store a plurality of riding training courses. The rider database is configured to store rider characteristic data and riding sensing data. The course recommendation processing module is connected with the course database and the rider database and configured to analyze the rider characteristic data and the riding sensing data to obtain a user riding characteristic vector, compare the user riding characteristic vector and a course characteristic vector of each of the plurality of riding training courses to obtain a plurality of matching values of the plurality of riding training courses, and set at least one recommendation course from the plurality of riding training courses according to at least one of the matching values which is greater than a threshold.

One of the exemplary embodiments is to provide a training course recommendation method for a training course recommendation device, which the training course recommendation device includes a rider database storing rider characteristic data and riding sensing data, a course database storing a plurality of riding training courses, and a course recommendation processing module. The training course recommendation method includes steps of analyzing, by the course recommendation processing module, the rider characteristic data and the riding sensing data to obtain a user riding characteristic vector: comparing, by the course recommendation processing module, the user riding characteristic vector with a course characteristic vector of each of the plurality of riding training courses to obtain a plurality of matching values of the plurality of riding training courses: and setting, by the course recommendation processing module, at least one recommendation course from the plurality of riding training courses according to at least one of the matching values which is greater than a threshold.

It is to be understood that both the foregoing general description and the following detailed description are provided by examples, and are intended to provide further explanation of the disclosure as claimed.

### BRIEF DESCRIPTION OF THE DRAWINGS

FIG. 1 is a block diagram illustrating a training course recommendation device in accordance with one embodiment of the present disclosure.

FIG. 2 is a flowchart illustrating a training course recommendation method in accordance with one embodiment of the present disclosure.

FIG. 3 is a block diagram illustrating a training course recommendation device in accordance with one embodiment of the present disclosure.

### DETAILED DESCRIPTION

The technical terms “first”, “second” and the similar terms are used to describe elements for distinguishing the same or similar elements or operations and are not intended to limit the technical elements and the order of the operations in the present disclosure. Furthermore, the element symbols/alphabets can be used repeatedly in each embodiment of the present disclosure. The same and similar technical terms can be represented by the same or similar symbols/alphabets in each embodiment. The repeated symbols/alphabets are provided for simplicity and clarity and they should not be interpreted to limit the relation of the technical terms among the embodiments.

Reference will now be made in detail to the present embodiments of the disclosure, examples of which are illustrated in the accompanying drawings. Wherever possible, the same reference numbers are used in the drawings and the description to refer to the same or like parts.

To provide users with software to manage their exercise results, an electronic device is disposed on a bicycle trainer to receive sensing data, such as heart rate data from a heart rate sensor (which is disposed on the handlebar of the bicycle or worn on the user's body) and pedal frequency data from a pedal frequency sensor disposed on the bicycle trainer.

The related bicycle trainer only collects the sensing data and provides them to the user for reference but cannot provide the user with an appropriate training course for riding training based on the sensing data. A training course recommendation device and training course recommendation method of the present disclosure may analyze comprehensively the user's physical ability or sports ability, historical riding data (such as the types of tracks the user has challenged before), real-time riding sensing data, and course information features based on the simulating riding service to recommend the most appropriate riding training courses for the user to follow.

One of the technical solutions provided in the present disclosure is to install software on an electronic device electrically or communicatively connected with the bicycle trainer, and the software is executed by the electronic device that is connected with the bicycle trainer to compute the riding training courses that are the most appropriate for the user, and then a course list is displayed on a monitor (such as the display of the electronic device or the display connected with the electronic device) for the user to select or subscribe the training courses. Accordingly, the user may follow the riding training in the simulated riding service based on the subscribed training courses.

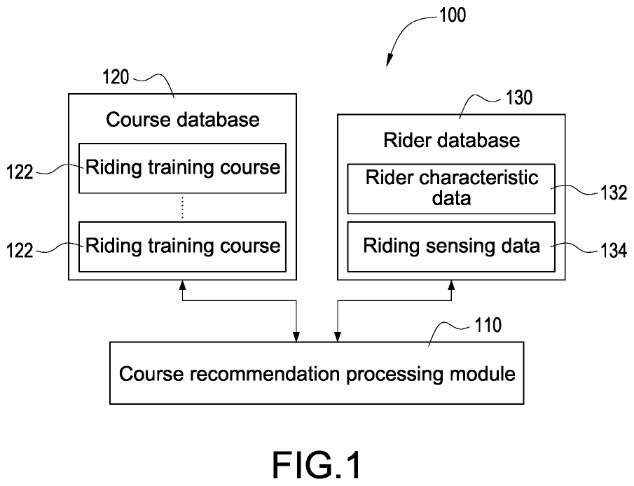

Reference is made to FIG. 1. FIG. 1 is a block diagram illustrating a training course recommendation device in accordance with one embodiment of the present disclosure. The training course recommendation device 100 includes a course recommendation processing module 110, a course database 120, and a rider database 130. The course recommendation processing module 110 is respectively connected with the course database 120 and the rider database 130.

In one embodiment, the training course recommendation device 100 may be the portable electronic device, the tablet computer, the notebook computer, or the electronic device including processors and/or storage that executes the application installed thereon or in clouds. The user rides the bicycle that is disposed on the bicycle trainer, and the training course recommendation device 100 is connected to the bicycle trainer to perform the computations mentioned above. In another embodiment, the training course recommendation device 100 may be the built-in electronic device of the bicycle trainer.

In one embodiment, course recommendation processing module 110 may be but is not limited to the central processing unit (CPU), System on Chip (SoC), application processor, digital signal processor, or specific function processing chip or controller.

In one embodiment, the course database 120 is configured to store a plurality of riding training courses 122. The content of the riding training course 122 in the present disclosure includes a plurality of training sections, and each of the plurality of training sections includes a duration, a revolution per minute (RPM), and a functional threshold power section (FTP section). The RPM indicates the speed of the pedal being pedaled in one circle (or the circle number of the pedal being pedaled per minute). The FTP section indicates the average power that the user rides consistently every 60 minutes. The FTP is the most used criterion of bicycle training.

Because each of the riding training courses 122 reflects the physical ability or the training intensity of the user, the riding training course 122 may be classified into different course categories including: an introductory course, a general course, an intensive course, a team-development course, a professional course, and an elite course. In one embodiment, the training course recommendation device 100 takes the context of the riding training course 122 as the keyword and searches for the course which suits the user by using the keyword. The context of the riding training course 122 may be the words such as “introductory”, “general”, “intensive”, “team-development”, “professional”, and “elite”.

For example, TABLE I shows the menu of the riding training course 122. The menu is for the general course and the context is “general”. The general course includes one warm-up section and two alternative high-intensity sections and low-intensity sections. The professional coach may design the menu of the riding training courses based on the training needs.

TABLE I
the riding training courses (the context: “general”)

| Training sections | Duration(minutes) | RPM | FTP |
|---|---|---|---|
| warm-up | 10 | greater than 85 | 40~73% |
| high-intensity | 2 | greater than 85 | 73% |
| low-intensity | 5 | greater than 85 | 53% |
| high-intensity | 2 | greater than 85 | 73% |
| low-intensity | 5 | greater than 85 | 53% |

In one embodiment, the rider database 130 is configured to store rider characteristic data 132 and riding sensing data 134.

In one embodiment, the rider characteristic data 132 may be but is not limited to a user name, a birthday, a body height, a body weight, or other data containing information or the physical ability of the user.

In one embodiment, the training course recommendation device 100 provides the simulating riding service, that is, the training course recommendation device 100 simulates the road condition that the user rides on and makes the user experience through the simulating riding service that incorporates changing routes or road conditions. For example, the user rides a bicycle disposed on a trainer and experiences simulated riding that incorporates virtual scenery and terrain. As the user rides, he or she feels the corresponding resistance of the bicycle based on the simulated terrain.

In one embodiment, the riding sensing data 134 is the data of the simulating riding service. The data of the simulating riding service is the real-time riding data generated when the user rides, including the real-time road information (such as the total road length, the position in the road, and the road gradient), the pedaling sensing data, the heart rate data of the user, and so on. The pedaling sensing data is generated by the pedaling sensor (not shown in figures) disposed on the trainer or the bicycle, and the heart rate data is generated by the heart rate sensor disposed on the handlebars of the bicycle or the heart rate sensor of the wearable device (not shown in figures) worn on the user's body.

In one embodiment, the course recommendation processing module 110 is configured to analyze the rider characteristic data 132 and the riding sensing data 134 to obtain the user riding characteristic vector. The user riding characteristic vector represents information on the riding performance of the user and is described below.

In one embodiment, the course recommendation processing module 110 analyzes the content of the riding training course 122 to obtain a course characteristic vector of each riding training course 122. The course characteristic vector represents information on the riding training course 122 and is described below.

In one embodiment, the course recommendation processing module 110 computes at least one of the riding training courses 122 that suits the user based on the user riding characteristic vector and the course characteristic vector and provides the riding training course 122 computed to the user for subscribing. The process is described below.

In one embodiment, the course recommendation processing module 110 is configured to analyze the rider characteristic data 132 and the riding sensing data 134 to obtain the user riding characteristic vector and compare the user riding characteristic vector with the course characteristic vector of each riding training course 122 to obtain a matching value corresponding to each riding training course 122. In the present disclosure, the matching value of the riding training course 122 represents the exercise intensity of a menu of the riding training course 122 that suits the user in the simulating riding service. The greater the matching value of the riding training course 122, the more suitable it is for the user to perform the riding exercise by using the riding training course 122 at his or her current body status.

In one embodiment, the training course recommendation device 100 automatically sets or be manually set a threshold, and the course recommendation processing module 110 sets at least one recommendation course from at least one of the plurality of riding training courses 122 according to the matching value(s) which is(are) greater than the threshold. The recommendation course suits the user represented by the rider characteristic data.

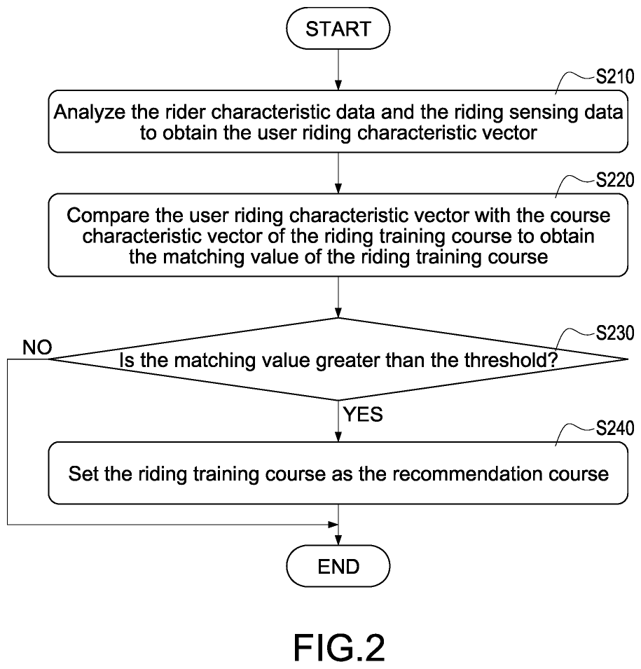

For the sake of understanding the disclosure, the following statement of FIG. 2 incorporates all the illustrations and statements of FIG. 1. FIG. 2 is a flowchart illustrating a training course recommendation method in accordance with one embodiment of the present disclosure. The training course recommendation method is executed by the training course recommendation device 100 in FIG. 1.

In step S210, the course recommendation processing module 110 analyzes the rider characteristic data 132 and the riding sensing data 134 to obtain the user riding characteristic vector.

In one embodiment, the course recommendation processing module 110 inputs the rider characteristic data 132 and the riding sensing data 134 to a trained deep learning module. After the deep learning module computes, the course recommendation processing module 110 outputs the user riding characteristic vector of the user. For example, the user riding characteristic vector is a vector “01011000”.

In one embodiment, the user riding characteristic vector is associated with a rider attribute. For example, the rider attribute associated with the user riding characteristic vector includes different ability types of the user including: the introductory type, the general type, the intensive type, the team-development type, the professional type, and the elite type.

In one embodiment, the course recommendation processing module 110 pre-defines the meaning of the numbering value of the user riding characteristic vector (i.e., the rider attribute associated with the user riding characteristic vector). For example, the numbering value “01011000” of the user riding characteristic vector represents that the user belongs to the professional type.

In one embodiment, the deep learning module may be but is not limited to the neural network model, the residual network model, or the model trained by other artificial intelligence algorithms.

In step S220, the course recommendation processing module 110 compares the user riding characteristic vector with each course characteristic vector of the riding training course 122 to obtain the matching value of each riding training course 122 for the user.

In one embodiment, the course recommendation processing module 110 executes a natural language processing in the context of the riding training course 122 (such as the context “introductory” or “general”) to generate the course characteristic vector of each riding training course 122. For example, the course characteristic vector is the numbering value “01011000”.

In one embodiment, the course characteristic vector is associated with the rider attribute. For example, the rider attribute represents the training intensities that the user belongs to, such as the introductory type, the general type, the intensive type, the team-development type, the professional type, or the elite type. In other words, the riding training course 122 contains the context (for the natural language processing) and the context is associated with the rider attribute (used for designing the menu of the riding training courses).

In one embodiment, the course recommendation processing module 110 pre-defines the meaning of the numbering value of the course characteristic vector (i.e., the rider attribute associated with the course characteristic vector). For example, the numbering value of the course characteristic vector is “01011000”, so the riding training course 122 represents the professional type.

In one embodiment, the course recommendation processing module 110 respectively computes a vector distance between the user riding characteristic vector and the course characteristic vector to obtain the matching value of the riding training course 122. If the vector distance is small, it represents that the user riding characteristic vector is similar to the course characteristic vector. In other words, the riding training course 122 corresponding to the course characteristic vector suits the user. On the contrary, if the vector distance is large (i.e., the numbering value is large), it represents that the user riding characteristic vector is different from the course characteristic vector. In other words, the riding training course 122 corresponding to the course characteristic vector does not suit the user.

In one embodiment, the vector distance between the user riding characteristic vector and the course characteristic vector is inversely proportional to the matching value. For example, if the vector distance is small, the matching value is large (i.e., the priority of the riding training course 122 which is recommended to the user is high).

In step S230, the course recommendation processing module 110 respectively determines whether the matching value of each riding training course 122 is greater than the threshold and filters the riding training course 122 which suits the user according to the matching value which is greater than the threshold. If the matching value of the riding training course 122 is greater than the threshold, it represents that the riding training course 122 suits the user, and step S240 is performed. If the matching value of the riding training course 122 is not greater than the threshold, it represents that the riding training course 122 does not suit the user, and the process is finished.

In step S240, the course recommendation processing module 110 sets the riding training course 122 which has the matching value greater than the threshold as the recommendation course.

In one embodiment, the recommendation course is the training course that suits the user to whom the rider characteristic data belongs. For example, the course recommendation processing module 110 respectively analyzes and compares the rider characteristic data 132 of each user with the riding sensing data 134 to obtain at least one recommendation course that suits the user from the plurality of riding training courses 122. Therefore, the content of the recommendation course is different from user to user.

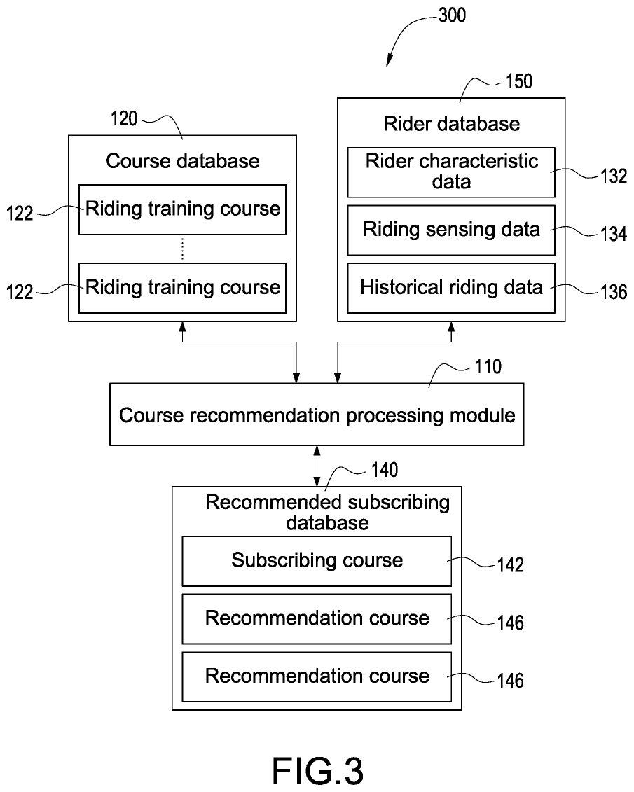

Reference is made to FIG. 3. FIG. 3 is a block diagram illustrating a training course recommendation device in accordance with one embodiment of the present disclosure. The training course recommendation device 300 includes the course database 120, the rider database 150, and a recommended subscribing database 140. Compared with FIG. 1, in FIG. 3 the training course recommendation device 300 further includes the recommended subscribing database 140, and the rider database 150 stores historical riding data 136. The historical riding data 136 records the information of the road (such as the total road length, the position in the road, and the road gradient) that the user rode on in the simulating riding service in the past. For example, the training course recommendation device 300 retrieves the types of race tracks that the user challenged in the simulating riding service and obtains the road information based on the race tracks.

In one embodiment, the recommended subscribing database 140 is connected with the course recommendation processing module 110. The recommended subscribing database 140 is configured to store a subscribing course 142 and at least one recommendation course 146.

In one embodiment, after filtering the at least one recommendation course 146 which suits the user from the riding training courses 122, the course recommendation processing module 110 stores the at least one recommendation course 146 to the recommended subscribing database 140.

In one embodiment, the course recommendation processing module 110 outputs the at least one recommendation course 146 to a display device (not shown in figures) that shows the information, and the user may select or subscribe one or more courses among the at least one recommendation course 146.

For example, the user may decide to subscribe one or more of the recommendation course(s) 146 by browsing the contents of the one or more recommendation courses 146. In one embodiment, the content of each recommendation course 146 includes a plurality of training sections, and each of the training sections respectively includes a duration (minute) and the RPM and the FTP section required in the duration. The content of the recommendation course 146 is similar to the content of the riding training course 122 in TABLE I and it is not repeated herein. The display device displays the numbering value of the RPM and the numbering value of the FTP section of the at least one recommendation course 146, and the user may decide whether to subscribe the recommendation course 146 or which recommendation course 146 to subscribe.

In one embodiment, the course recommendation processing module 110 receives the recommendation course 146 that the user subscribes and tags the recommendation course 146 as the subscribing course 142. Furthermore, the course recommendation processing module 110 arranges the training dates or training cycles, and the user may use the subscribing course 142 to perform the riding training by following the arranged dates or cycles.

In one embodiment, when the user performs the riding training, the rider database 150 receives and stores through a communication module (not shown in figures) of the training course recommendation device 300 an actual revolution per minute (actual RPM) and an actual functional threshold power section (actual FTP section) in an actual training time of the user training. Specifically, at least one sensor (not shown in figures, such as the velocity sensor or the pedaling frequency sensor) is disposed on the bicycle that the user rides, and the at least one sensor senses the actual RPM and the actual FTP section when the user performs the riding training, and the training course recommendation device 300 transmits the actual RPM and the actual FTP section through the communication module to store the actual RPM and the actual FTP section in the rider database 150.

In one embodiment, the course recommendation processing module 110 respectively compares the actual training time, the actual RPM, and the actual FTP section with the duration, the RPM, and the FTP section of each training section planned in the subscribing course 142. For example, if in a first training section the duration of the subscribing course 142 is 10 minutes, the RPM is greater than 85 RPM, and the FTP section is 53%, the user has to do the best to satisfy the requirement that the RPM is greater than 85 RPM and the value of the FTP section is greater than 53% in 0 to 10 minutes when performing the riding training.

In one embodiment, the course recommendation processing module 110 sends notifying information about adjusting the actual training strength for the user according to the comparing result. For example, if in 10 minutes the actual RPM is 90 RPM (which is greater than 85 RPM of the subscribing course 142) and the FTP section is 73% (which is greater than the FTP section 53% of the subscribing course 142), it represents that the training intensity is too strong and accordingly the course recommendation processing module 110 sends the notifying information to remind the user to release the movement and relax the body.

In one embodiment, the notifying information may be displayed on the display device (not shown in figures).

In one embodiment, the course recommendation processing module 110 stores the pedaling sensing data and the heart rate data associated with the user performing the riding training to be the riding sensing data 134 of the rider database 150 and records the road information (such as the total road length, the position in the road, and the road gradient) that the user rides each time in the simulating riding service to be the historical riding data 136 of the rider database 150.

For recommending the more suitable recommendation course 146 for the user the next time, after the user finishes the training course each time, the course recommendation processing module 110 executes the training course recommendation method in FIG. 2 again to update the content of the recommendation course 146 of the recommended subscribing database 140. Therefore, the training course recommendation device 100 and 300 provides the more suitable recommendation course 146 for the user based on the actual physical ability, the road information, the pedaling sensing data, and the heart rate data of the user.

Accordingly, the training course recommendation device and training course recommendation method of the present disclosure apply the deep learning module and the natural language processing techniques and comprehensively analyze the physical status of the user and the course information characteristic to accurately recommend suitable courses to the user so that the user may efficiently perform the riding training.

It will be apparent to those skilled in the art that various modifications and variations can be made to the structure of the present disclosure without departing from the scope or spirit of the disclosure. In view of the foregoing, it is intended that the present disclosure cover modifications and variations of this disclosure provided they fall within the scope of the following claims.

What is claimed is:

1. A training course recommendation device, comprising:
a course database configured to store a plurality of riding training courses;
a rider database configured to store rider characteristic data and riding sensing data; and
a course recommendation processing module, connected with the course database and the rider database and configured to analyze the rider characteristic data and the riding sensing data to obtain a user riding characteristic vector, compare the user riding characteristic vector and a course characteristic vector of each of the plurality of riding training courses to obtain a plurality of matching values of the plurality of riding training courses, and set at least one recommendation course from the plurality of riding training courses according to at least one of the matching values which is greater than a threshold.

2. The training course recommendation device of claim 1, wherein the course recommendation processing module is configured to input the rider characteristic data and the riding sensing data to a deep learning module to output the user riding characteristic vector, wherein the user riding characteristic vector is associated with a rider attribute.

3. The training course recommendation device of claim 2, wherein the course recommendation processing module is configured to execute a natural language processing to the plurality of riding training courses to generate the course characteristic vector of the plurality of riding training courses, wherein the course characteristic vector is associated with the rider attribute.

4. The training course recommendation device of claim 1, further comprising:
a recommended subscribing database, connected with the course recommendation processing module and configured to store the at least one recommendation course;
wherein the at least one recommendation course comprises a plurality of training sections, and each of the plurality of training sections comprises a duration, a revolution per minute (RPM), and a functional threshold power section (FTP section);
wherein the course recommendation processing module is configured to output the plurality of training sections of the at least one recommendation course to a display device for a user to select the at least one recommendation course.

5. The training course recommendation device of claim 4, wherein the rider database is configured to receive and store an actual training time, an actual revolution per minute (actual RPM), and an actual functional threshold power section (actual FTP section);
wherein the course recommendation processing module is configured to tag the at least one recommendation course selected as a subscribing course, respectively compare the actual training time, the actual RPM, and the actual FTP section with the duration, the RPM, and the FTP section of each of the plurality of training sections of the subscribing course, and send notifying information for adjusting actual training strength for the user according to a comparing result.

6. A training course recommendation method applied for a training course recommendation device, the training course recommendation device comprising a rider database storing rider characteristic data and riding sensing data, a course database storing a plurality of riding training courses, and a course recommendation processing module, and the training course recommendation method comprising:
analyzing, by the course recommendation processing module, the rider characteristic data and the riding sensing data to obtain a user riding characteristic vector;
comparing, by the course recommendation processing module, the user riding characteristic vector with a course characteristic vector of each of the plurality of riding training courses to obtain a plurality of matching values of the plurality of riding training courses; and
setting, by the course recommendation processing module, at least one recommendation course from the plurality of riding training courses according to at least one of the matching values which is greater than a threshold.

7. The training course recommendation method of claim 6, further comprising:
inputting, by the course recommendation processing module, the rider characteristic data (132) and the riding sensing data to a deep learning module to output the user riding characteristic vector, wherein the user riding characteristic vector is associated with a rider attribute.

8. The training course recommendation method of claim 7, further comprising:
executing, by the course recommendation processing module, a natural language processing to the plurality of riding training courses to generate the course characteristic vector of the plurality of riding training courses, wherein the course characteristic vector is associated with the rider attribute.

9. The training course recommendation method of claim 6, wherein the at least one of the recommendation courses comprises a plurality of training sections, and each of the plurality of training sections comprises a duration, a revolution per minute (RPM), and a functional threshold power section (FTP section), and the training course recommendation method further comprises:
outputting, by the course recommendation processing module, the plurality of training sections of the at least one recommendation course to a display device for a user to select the at least one recommendation course.

10. The training course recommendation method of claim 9, further comprising:
receiving and storing, by the rider database, an actual training time, an actual revolution per minute (actual RPM), and an actual functional threshold power section (actual FTP section);
tagging, by the course recommendation processing module, the at least one recommendation course selected as a subscribing course;
comparing respectively the actual training time, the actual RPM, and the actual FTP section with the duration, the RPM, and the FTP section of each of the plurality of training sections of the subscribing course; and
sending notifying information for adjusting actual training strength for the user according to a comparing result.
